(19) United States
(12) Patent Application Publication
(10) Pub. No.: US 2004/0123844 A1
(43) Pub. Date: Jul. 1, 2004

(54) Fuel feed unit

(75) Inventor: Michael Bampfer, Rotenburg (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/678,752

(22) Filed: Oct. 6, 2003

(30) Foreign Application Priority Data
Oct. 7, 2002 (DE) 10246725.0

(51) Int. Cl. F02M 37/04

(52) U.S. Cl. 123/509

(57) ABSTRACT

In a fuel feed unit (3), a pump holder (10) has a plurality of sheet-metal strips (13, 14) for limiting the transmission of structure-borne sound from a fuel pump (5) to an anti-surge pot (2). The sheet-metal strips (13, 14) can be manufactured cost-effectively and adapted to the particular fuel pump (5). This enables the fuel feed unit (3) to be manufactured particularly cost-effectively.

The invention relates to a fuel feed unit which is provided for arrangement in a fuel tank of a motor vehicle, having a fuel pump and having a pump holder which is to be fastened in the fuel tank and is intended for securing the fuel pump.

Fuel feed units of this type are in widespread use in modern motor vehicles and are known in practice. The pump holder of the known fuel feed unit is manufactured as a plastic part by injection molding and has a plurality of resilient elements for avoiding the transmission of annoying structure-borne sound from the fuel pump to adjacent components of the fuel tank. The pump holder is generally clipped to an anti-surge pot arranged in the fuel tank.

A disadvantage of the known fuel feed unit is that the pump holder is a component which is difficult to manufacture. A cost-intensive injection molding die is also required for this purpose.

The invention is based on the problem of designing a fuel feed unit of the type mentioned at the beginning in such a manner that it can be produced particularly cost-effectively and the transmission of structure-borne sound from the fuel pump is largely avoided.

This problem is solved according to the invention by the pump holder being manufactured, at least in a central region, from metal in order to acoustically isolate the fuel pump from adjacent components.

This design enables the transmission of the structure-borne sound to be obstructed by the region which is manufactured from metal. The region which is manufactured from metal can be assembled in a simple manner, for example from series components which are simple to manufacture or from standard components, such as, for example, spring elements. This avoids the provision of complex injection molds which are specially adapted for the particular fuel pump and the particular adjacent components. The region which is manufactured from metal can also be adapted with little outlay, for example by means of simple tests, to new fuel pumps. The fuel feed unit according to the invention can therefore be manufactured particularly cost-effectively without an increased transmission of structure-borne sound in comparison to the known fuel feed unit.

According to one advantageous development of the invention, the pump holder can be manufactured particularly cost-effectively if it has a sheet-metal strip in its central region.

According to another advantageous development of the invention, a designated elasticity of the pump holder can be ensured in a simple manner if the sheet-metal strip has corrugations. This also enables the sheet-metal strip to prestress the fuel pump, for example against the bottom of the anti-surge pot.

According to another advantageous development of the invention, a contribution is made to further suppressing the transmission of structure-borne sound if the region which is manufactured from metal has constrictions and/or enlargements.

According to another advantageous development of the invention, a contribution is made to further suppressing the transmission of structure-borne sound if the region which is manufactured from metal has different wall thicknesses.

According to another advantageous development of the invention, vibrations from the fuel pump are reliably damped by the pump holder if a resonant frequency of that region of the pump holder which is manufactured from metal lies outside the natural frequency of the fuel pump.

A contribution is made to simplifying the installation of the fuel feed unit according to the invention if the pump holder has at least one retaining ring for fastening it to an adjacent component, and has sheet-metal strips protruding in a star-shaped manner from the retaining ring. The retaining ring may be fastened, for example, to the anti-surge pot or to the fuel pump. The pump holder preferably has one retaining ring in each case on the anti-surge pot and on the fuel pump, the retaining rings being connected to each other via the sheet-metal strips.

A contribution is made to further simplifying the installation of the fuel feed unit according to the invention if the retaining ring and the sheet-metal strips are manufactured as a single piece.

According to another advantageous development of the invention, the outlay for adapting the pump holder for different fuel pumps and different fuel tanks can be kept particularly small if the retaining ring is manufactured from plastic and the sheet-metal strips are pressed into corresponding grooves of the retaining ring.

According to another advantageous development of the invention, the pump holder has particularly low stiffness transversely with respect to the longitudinal axis of a drive shaft of the fuel pump if that region of the pump holder which is manufactured from metal is arranged essentially parallel to the longitudinal axis of a drive shaft of the fuel pump. The fuel pump is able to move laterally, for example due to an imbalance in the drive shaft, without vibrations being transmitted to adjacent components of the fuel tank. For installation purposes, this enables the fuel pump to be fitted in a simple manner into an anti-surge pot.

The invention permits numerous embodiments. To further clarify its basic principle, one of these is illustrated in the drawing and will be described below. In the drawing

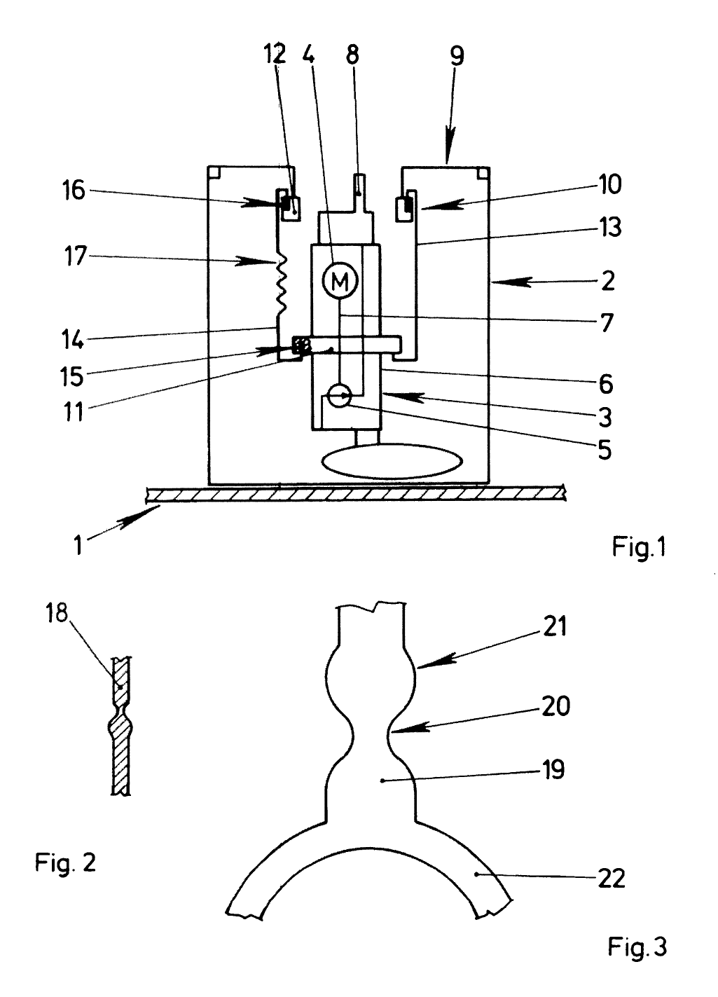

FIG. 1 shows schematically a fuel feed unit according to the invention,

FIG. 2 shows a longitudinal section of a sheet-metal strip of the fuel feed unit according to the invention from FIG. 1,

FIG. 3 shows a view of a sheet-metal strip of the fuel feed unit according to the invention from FIG. 1.

FIG. 1 shows an anti-surge pot 2 which is prestressed against a bottom of a fuel tank 1 of a motor vehicle together with a fuel feed unit 3. The fuel feed unit 3 has a fuel pump 5 which is driven by an electric motor 4. The fuel pump 5 and the electric motor 4 are arranged in a common housing 6 and are connected to each other via a drive shaft 7. The fuel pump 5 sucks up fuel from the anti-surge pot 2 and feeds it to a connection 8 of the fuel feed unit 3, which connection can be connected to a forward-flow line (not illustrated). A cover 9 is clipped onto the anti-surge pot 2. The cover 9 is connected to a pump holder 10.

The pump holder 10 has a retaining ring 11, 12, which is fastened to the cover 9 and to the housing 6 of the fuel pump 5, and has, in its central region, sheet-metal strips 13, 14 for connection of the retaining rings 11, 12. The retaining rings 11, 12 are manufactured here from plastic.

The sheet-metal strips 13, 14 extend essentially parallel to the drive shaft 7 of the fuel pump 5 and are pressed into grooves 15, 16 of the retaining rings 11, 12. Two sheet-metal strips 13, 14 are illustrated in the drawing. The pump holder 10 preferably has three sheet-metal strips 13, 14 which are arranged offset by 120° with respect to one another. As an alternative to the illustrated connection of the sheet-metal strips 13, 14 to the retaining rings 11, 12, the sheet-metal strips 13, 14 and the retaining rings 11, 12 can be manufactured as a single piece from metal. Components of this type can be manufactured in a simple manner by punching and deep-drawing. One of the sheet-metal strips 14 has corrugations 17 and is therefore designed such that it is elastic in its longitudinal direction. The sheet-metal strips 13, 14 largely suppress the transmission of structure-borne sound from the fuel pump 5 to the anti-surge pot 2.

FIG. 2 shows a further embodiment of the sheet-metal strip 18 in longitudinal section, in which different wall thicknesses have been produced, for example by stamping. FIG. 3 shows a view of a further embodiment of a sheet-metal strip 19 with a constriction 20 and an enlargement 21. The sheet-metal strip 19 is manufactured as a single piece with a retaining ring 22 which is provided for fastening it to the fuel pump 5 from FIG. 1. The configuration of the sheet-metal strips 18, 19 according to FIGS. 2 and 3 obstructs the transmission of structure-borne sound from the fuel pump 5 illustrated in FIG. 1 to the anti-surge pot 2.

1. A fuel feed unit which is provided for arrangement in a fuel tank of a motor vehicle, having a fuel pump and having a pump holder which is to be fastened in the fuel tank and is intended for securing the fuel pump, characterized in that the pump manufactured, in that the pump holder (10) is manufactured, at least in a central region, from metal in order to acoustically isolate the fuel pump (5) adjacent components.

2. The fuel feed unit as claimed in claim 1, characterized in that the pump holder (10) has a sheetmetal strip (13, 14, 18, 19) in its central region.

3. The fuel feed unit as claimed in claim 1, characterized in that the sheet-metal strip has corrugations (17).

4. The fuel feed unit as claimed in claim 1, characterized in that the region which is manufactured from metal has constrictions (20) and/or enlargements (21).

5. The fuel feed unit as claimed in claim 1, characterized in that the region which is manufactured from metal has different wall thicknesses.

6. The fuel feed unit as claimed in claim 1, characterized in that a resonant frequency of that region of the pump holder (10) which is manufactured from metal lies outside the natural frequency of the fuel pump (5).

7. The fuel feed unit as claimed in claim 1, characterized in that the pump holder (10) has at least one retaining ring (11, 12, 22) for fastening it to an adjacent component, and has sheet-metal strips (13, 14, 19) protruding in a starshaped manner from the retaining ring (11, 12, 22).

8. The fuel feed unit as claimed in claim 1, characterized in that the retaining ring (22) and the sheet-metal strip manufactured as a single piece.

9. The fuel feed unit as claimed in claim 1, characterized in that the retaining ring (11, 12) is manuactured from plastic and the sheet-metall stip (13,14) are presed into corresponding grooves (15, 16) of the retaining ring (11, 12).

10. The fuel feed unit as claimed in claim 1, characterized in that that region of the pump holder (10) which is manufactured fom metal is arranged essentially parallel to the longitudinal axis of a drive shaft (7) of the fuel pump (5).
